(19) United States
(12) Patent Application Publication
(10) Pub. No.: US 2015/0290994 A1
(43) Pub. Date: Oct. 15, 2015

(54) VARIABLE HEIGHT VEHICLE

(71) Applicant: Matthew W. Dames, Clarion, IA (US)

(72) Inventor: Matthew W. Dames, Clarion, IA (US)

(73) Assignee: HAGIE MANUFACTURING COMPANY, Clarion, IA (US)

(21) Appl. No.: 14/248,682

(22) Filed: Apr. 9, 2014

(51) Int. Cl. B60G 17/00; B60G 7/00; B62D 49/06

(52) U.S. Cl. CPC B60G 17/00; B62D 49/06; B60G 7/001

(57) ABSTRACT

A system and method for raising and lowering a vehicle. The system includes a four-bar linkage provided for each wheel. The four-bar linkage includes a first three linkage assembly and a second three linkages assembly. The first three linkage assembly maintains the orientation of the vehicle relative to the wheel during the lifting and lowering while the second linkage assembly provides the power to lift and lower the vehicle. Power provided by a hydraulic cylinder is pivotably coupled to the second linkage assembly. A steering assembly is provided between the four-bar linkage assembly and the wheel. The four-bar linkage vehicle lifting assembly may be provided on agricultural vehicles, construction vehicles, or any desired vehicle.

### FIELD OF THE INVENTION

The disclosed embodiments relates in general to a variable height vehicle and, more specifically, to a variable height vehicle with a constant wheelbase

### BACKGROUND OF THE INVENTION

Variable height vehicles are known in the art. Such vehicles may be used for high clearance agricultural uses such as spray boom applicators or may be used to level the vehicle over sloped or otherwise uneven terrain.

One type of such prior art machine uses swing arms coupled to each wheel. While this construction allows for the wheels of the vehicle to be independently raised and lowered, such constructions have numerous drawbacks. One such drawback is the limited height adjustment associated with most prior art swing arms. An additional drawback of such prior art devices is that raising and lowering the height of a vehicle using swing arms changes the length of the wheelbase of the vehicle, causing additional problems such as instability and an altered turn radius.

It is also known in the prior art to provide vehicles with wheels extended by hydraulic cylinder. While it is possible to use hydraulic cylinders to raise and lower wheels of a vehicle directly while maintaining a predetermined wheel base length, hydraulic cylinders are only feasible for raising and lowering vehicles a short distance. Raising the vehicles a longer distance requires large, heavy, and expensive hydraulic cylinders. Accordingly, it is known in the art to use hydraulic cylinders in association with a scissor assembly to increase the length of the height adjustment with smaller hydraulic cylinders. One drawback associated with such devices is the scissor assemblies alter the wheelbase of the vehicle, leading to instability and an altered turn radius.

It is also known in the art to use other hydraulically actuated linkage assemblies. While such systems do increase the distance traveled over a straight hydraulic cylinder, to obtain a large vehicle height adjustment, such linkages have to be large and cumbersome. It would therefore be desirable to provide a variable height vehicle with a robust compact system for varying vehicle height by a large distance while maintaining the wheelbase and turn radius of the vehicle. The difficulties discussed herein above are sought to be eliminated by the present invention.

### SUMMARY OF THE DISCLOSED SUBJECT MATTER

The present invention includes systems and methods for raising and lowering the height of a vehicle. The system uses a four-bar linkage assembly coupled to the frame of a vehicle. The four-bar linkage assembly includes a first linkage assembly and a second linkage assembly. The first linkage assembly includes a first linkage pivotably coupled to the frame, a second linkage pivotably coupled to the first linkage, and a third linkage pivotably coupled to the frame and to the second linkage. The second linkage assembly includes a fourth linkage pivotably coupled to the frame, a fifth linkage pivotably coupled to the fourth linkage, and a sixth linkage pivotably coupled to the frame and to the fifth linkage. A linear actuator is coupled to the sixth linkage, to raise and lower the four-bar linkage assembly in a generally straight line motion.

The features and advantages described in this summary and the following detailed description are not all-inclusive. Many additional features and advantages may be apparent to one of ordinary skill in the art in view of the drawings, specification and claims presented herein.

### BRIEF DESCRIPTION OF THE DRAWINGS

The present invention will now be described, by way of example, with reference to the accompanying drawings in which:

FIG. 1 illustrates a side elevation of the variable height vehicle shown with the vehicle in the lifted position in accordance with one embodiment;

FIG. 2 illustrates the variable height vehicle of FIG. 1 shown with the vehicle in the lowered position;

FIG. 3 illustrates a front perspective view of the height adjustment assembly in accordance with one embodiment;

FIG. 4 illustrates a top perspective view in partial cutaway of the height adjustment assembly of FIG. 3;

FIG. 5 illustrates a side elevation of a leveling linkage in accordance with one embodiment in the lowered position;

FIG. 6 illustrates a side elevation of a leveling linkage in accordance with one embodiment in the raised position;

FIG. 7 illustrates a front elevation of the rear of a height adjustment assembly in accordance with one embodiment;

FIG. 8 illustrates a side elevation of a lifting linkage in accordance with one embodiment in the lowered position;

FIG. 9 illustrates a side elevation of a lifting linkage in accordance with one embodiment in the raised position;

FIG. 10 illustrates a front elevation of a variable height vehicle moving over sloped terrain in accordance with one embodiment.

### DETAILED DESCRIPTION OF THE DRAWINGS

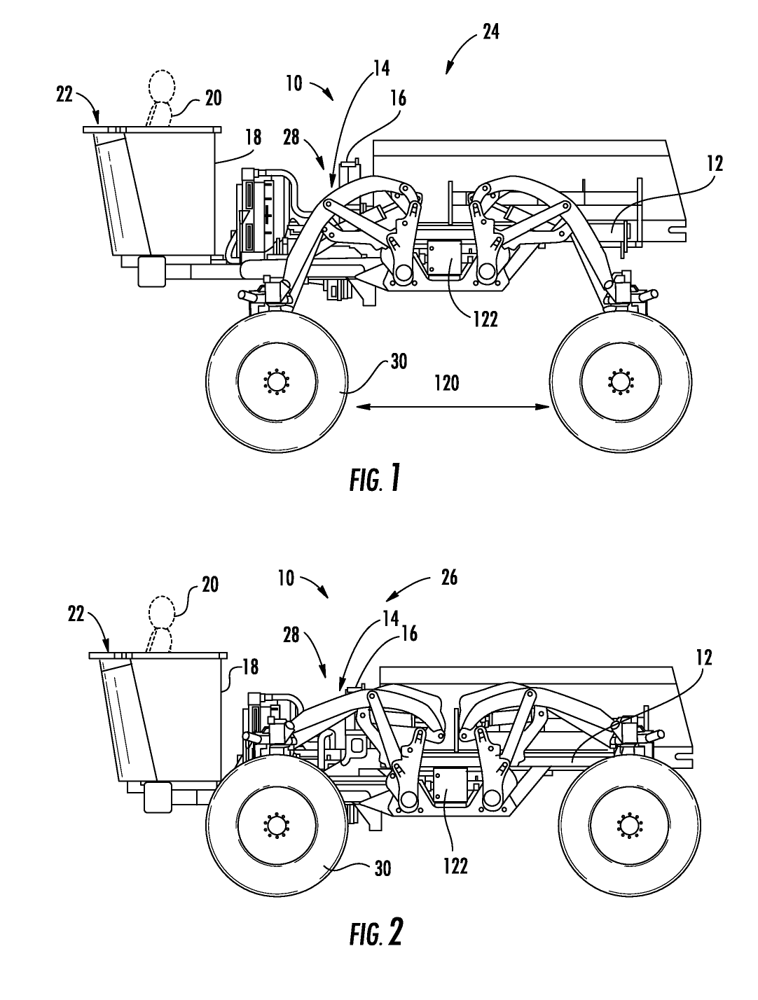

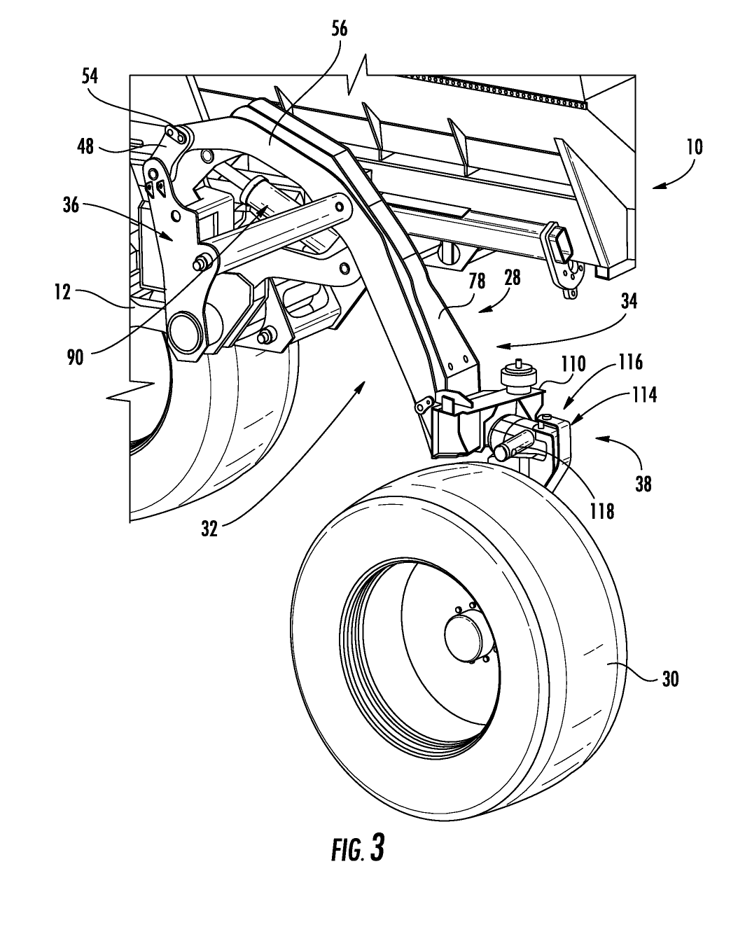

As shown in FIG. 1, a variable height vehicle (10) is provided with a frame (12). Coupled to the frame (12) are an engine (14), a hydraulic pump (16), and operator station (18). A user (20) controls the vehicle (10) from a control panel (22) located on the operator station (18). From the operator station (18), the user (20) may lower the vehicle (10) from the lifted orientation (24) shown in FIG. 1 to the lowered orientation (26) shown in FIG. 2.

The vehicle (10) is lifted and lowered by a plurality of closed chain linkages, which are preferably four-bar linkage assemblies (28). Separate four-bar linkage assemblies (28) are provided for each wheel (30) of the vehicle. As the four-bar linkage assemblies (28) are similar except for being mirror images of one another, description will be limited to a single four-bar linkage assembly (28).

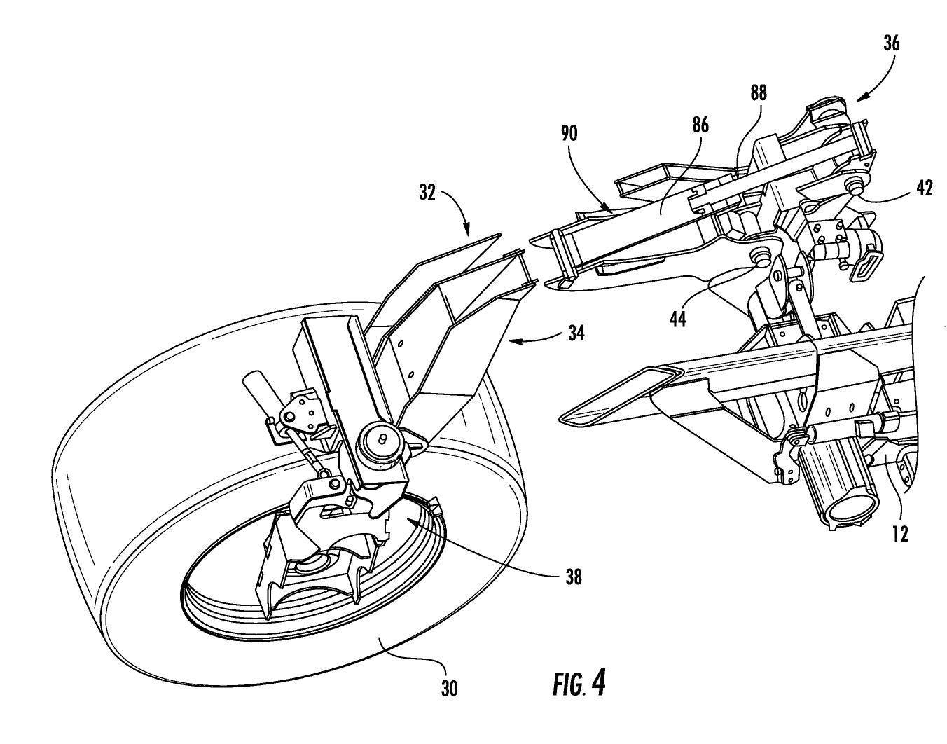

As shown in FIGS. 3-4, the four-bar linkage assembly (28) includes a first linkage assembly, otherwise known as the leveling linkage (32), and a second linkage assembly, otherwise known as the lifting linkage (34). Providing the other two components of the four-bar linkage assembly are a leg support structure (36) and a leg (38). The leg support structure (36) is secured to the frame (12) and the leg (38) is coupled to the wheel (30).

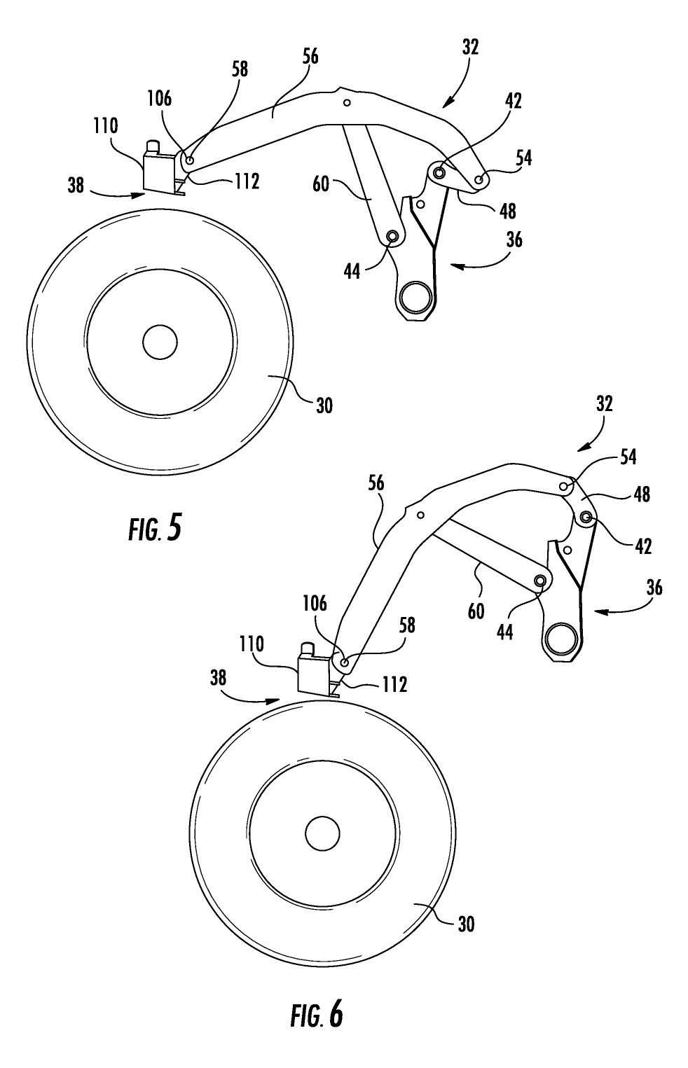

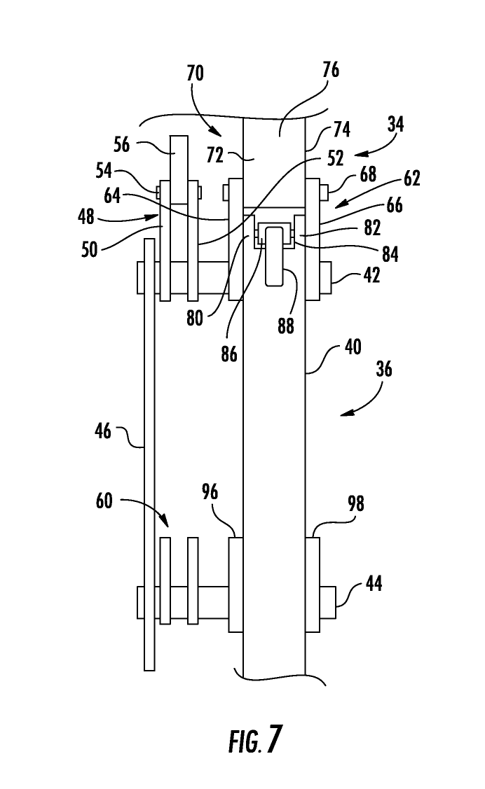

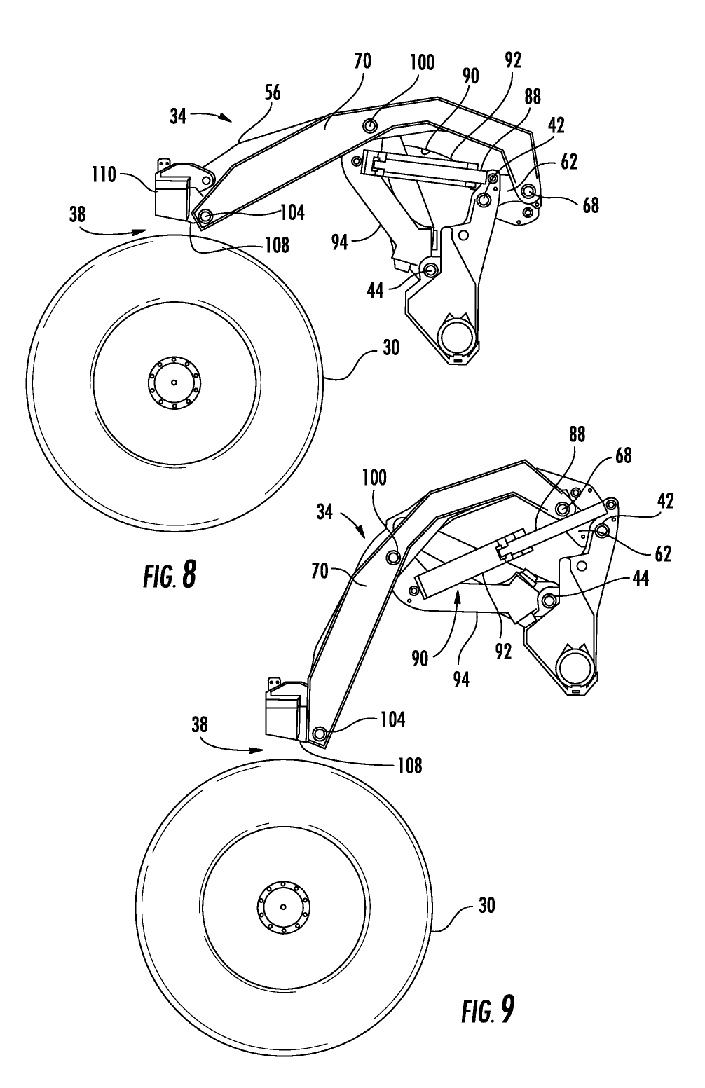

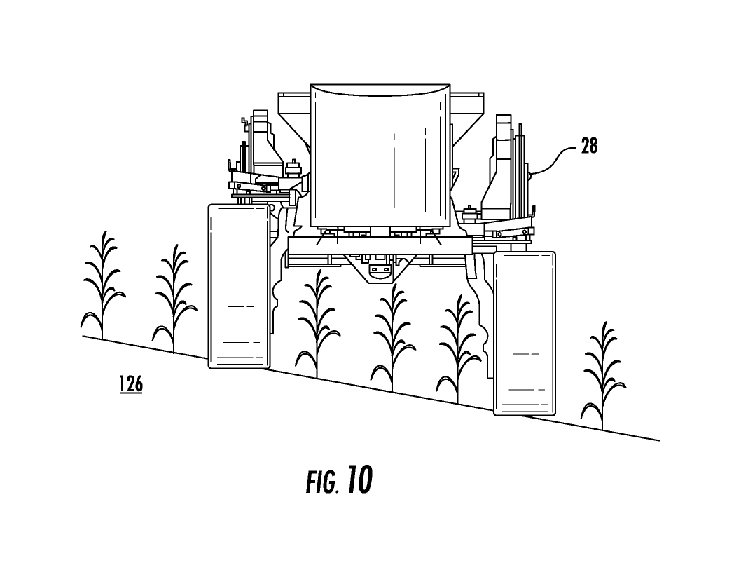

The leveling linkage (32) maintains the orientation of the leg (38) and wheel (30) as the vehicle (10) is raised and lowered by the lifting linkage (34). (FIGS. 1 and 5-6). The leveling linkage (32) also maintains the wheelbase and turning radius of the vehicle consistent as the vehicle (10) is raised and lowered. The leveling linkage (32) is pivotably coupled to the leg support structure (36). As shown in FIG. 7, the leg support structure (36) includes a main brace (40) secured to the frame (12). (FIGS. 1, 3, 4, and 7). Coupled to the main brace (40) by a pair of pins (42 and 44) is an outer plate (46). Pivotably secured to the upper pin (42) between the main brace (40) and the outer plate (46) is a first linkage (48) including a first plate (50) and second plate (52). The first linkage (48) is coupled, in turn, by a pin (54) to a second linkage (56) as shown in FIGS. 5-6, the second linkage (56) is a long curved steel plate provided with a hole (58) so that the second linkage (56) may be connected to the leg (38) via the steering knuckle (110). The second linkage (56) is pinned to the steering knuckle (110) and the steering knuckle (110) is secured to the leg (38). As shown in FIGS. 5-10, a third linkage (60) is pivotably coupled to the pin (44) between the main brace (40) and outer plate (46). The third linkage (60) is pivotably coupled on its opposite end to the second linkage (56) at a point between the first linkage (48) and the leg (38).

The lifting linkage (34) includes a fourth linkage (62) having a first plate (64) and second plate (66) pivotably secured to the pin (42) on opposite sides of the main brace (40). (FIGS. 3-5, and 7-10). The fourth linkage (62) is coupled in turn, by a pin (68) to a fifth linkage (70). The fifth linkage (70) may be of any desired design. In the preferred embodiment, the fifth linkage (70) has a pair of side plates (72 and 74) welded to a bottom plate (76) and a top plate (78). The fifth linkage (70) preferably tapers in width from the leg (38) toward the fourth linkage (62).

As shown in FIG. 7, the main brace (40) is provided with a pair of ears (80 and 82) to hold a pin (84). Provided around the pin (84) is a sleeve (86) coupled to a piston rod (88) of a linear actuator such as a hydraulic cylinder (90). (FIGS. 7-9). The cylinder barrel (92) of the hydraulic cylinder (90) is pivotably secured to a sixth linkage the sixth linkage (94) is a pair of plates (96 and 98) coupled around the pin (44) on either side of the main brace (40). The sixth linkage (94) is coupled on its other end to either side of the fifth linkage (70) via a pin (100) located between the ends of the fifth linkage (70). Unlike the third linkage (60), which is straight, the sixth linkage (94) is preferably provided with a curve (102) to allow for a longer hydraulic cylinder (90) to be located between the leg support structure (36) and sixth linkage (94). The hydraulic cylinder (90) is coupled to the hydraulic pumps (16) by means known in the art.

The four-bar linkage assembly (28) is coupled to the leg (38) by two pins (104 and 106) FIGS. 5-9. The first pin (104) is secured between two steel ears (108) welded to a steering knuckle (110). The pin (104) passes through the fifth linkage (70) that is provided between the ears (108). The other pin (106) is secured to another ear (112) welded to the steering knuckle (110). The second linkage (56) is secured to the steering knuckle (110) at a higher point than the fifth linkage (70) to allow the second linkage (56) and fifth linkage (70) to act as parallel linkages to raise and lower the vehicle (10) without increasing the wheelbase (FIGS. 3-9). The leg (38) includes the steering knuckle (110) the depending shaft/sleeve assembly (114) pivotably coupled thereto and the steering assembly (116) that includes a hydraulic cylinder (118) to pivot the shaft within the sleeve to turn the wheel (30) coupled to the shaft. The hydraulic cylinder (118) is coupled to the hydraulic pump (16) in a manner such as that known in the art.

By providing the steering assembly (116) between the suspension and the wheel, complicated prior art steering system linkage assemblies can be eliminated. Additionally, by providing the steering assembly (116) below the suspension, steering tolerances are tighter making the vehicle (10) easier to manage and allowing auto-steer systems to function more efficiently. Using the four-bar linkage described above allows a smaller hydraulic cylinder to lift the vehicle (10) a greater distance. In the preferred embodiment, the hydraulic cylinder is preferably a 61-centimeter hydraulic cylinder, which lifts the vehicle (10) 122 centimeters. Alternatively, any desired length of cylinders may be used from below 10 centimeters to in excess of 2 meters in length, depending on the application. Similarly, while in the preferred embodiment, the length of the cylinder to the lift height of the vehicle is 1 to 2, the angles and connection points of the four-bar linkage (28) may be modified to create a lift ratio anywhere from above 1 to 1, to 1 to 3 or more. The four-bar linkage assembly of the present invention also allows for four wheel independent suspension and a large under vehicle clearance that eliminates axles spanning the complete width of the vehicle. While the linkages of the four-bar linkage (28) in the preferred embodiment are steel, they may be constructed of any desired dimensions or material.

When it is desired to operate the vehicle (10) of the preferred embodiment, the user (20) manipulates the control panel (22) to direct hydraulic fluid from the hydraulic pump (16) to the hydraulic cylinders (90). The hydraulic cylinders (90) push the ends of the sixth linkages (94) away from the main braces (40), causing the fourth linkages to rotate around the main braces (40). This pushes the fourth linkages (62) downward in a straight line, thereby raising the vehicle (10) without changing the length of the wheelbase of the vehicle (10). When it is desired to lower the vehicle (10), the user (20) manipulates the control panel (22) to return hydraulic fluid from the hydraulic cylinders (90), thereby contracting the hydraulic cylinders (90), drawing the ends of the sixth linkages (94) toward the main brace (40) and rotating the fourth linkages (62) in the opposite direction. This draws the fifth linkages (70) upward, lowering the vehicle (10) without changing the length of the wheelbase (120).

As shown in FIG. 1, the vehicle (10) may also be provided with an electronic control unit (122) such as those known in the art. The electronic control unit (122) may be coupled to various other systems such as global positioning satellites, gyroscopic, or laser systems to monitor the ground (124). The ECU (122) may be programmed to maintain the vehicle (10) level even when the vehicle (10) is moving across uneven terrain (126) in a manner such as that shown in FIG. 10. As shown, either the user (20) or the Electronic Control Unit (122) may extend the four-bar linkage assemblies (28) on one side of the vehicle (10) and retract the four-bar linkage assemblies (28) on the opposite side of the vehicle (10) to allow the vehicle (10) to move along a slope while maintaining the vehicle (10) level. This type of maneuver is especially advantageous for vehicles carrying a large shifting weight and/or vehicles with a high center of gravity.

Although the invention has been described with respect to a preferred embodiment thereof, it is to be understood that it is not to be so limited since changes and modifications can be made therein which are in within the full, intended scope of this invention as defined by the appended claims.

What is claimed is:

1. A vehicle comprising:
(a) a frame;
(b) closed chain linkage assembly comprising:
(i) a first linkage assembly comprising:
[a] a first linkage pivotably coupled to the frame;
[b] a second linkage pivotably coupled to the first linkage;
[c] a third linkage pivotably coupled to the frame and pivotably coupled to the second linkage;
(ii) a second linkage assembly having a lifting height of at least one meter comprising;
[a] fourth linkage pivotably coupled to the frame;
[b] a fifth linkage pivotably coupled to the fourth linkage;
[c] a sixth linkage pivotably coupled to the frame and pivotably coupled to the fifth linkage;
(iii) a leg pivotably coupled to the first linkage and to the second linkage;
(c) a linear actuator pivotably coupled to the sixth linkage; and
(d) a wheel coupled to the leg.

2. The vehicle of claim 1, wherein the third linkage is pivotably coupled to the second linkage at a point located between the first linkage and the leg.

3. The vehicle of claim 2, wherein the sixth linkage is pivotably coupled to the fifth linkage at a point located between the fourth linkage and the leg.

3. The vehicle of claim 1, wherein the sixth linkage is pivotably coupled to the fifth linkage at a point located between the fourth linkage and the leg.

4. The vehicle of claim 1, wherein the wheel has a diameter of at least one and one-half meters, and a width no greater than one meter.

5. The vehicle of claim 1, further comprising a supplemental wheel mounted to the frame, wherein a midline of the supplemental wheel is mounted to the frame substantially parallel to the frame at least two and one-half meters from a midline of the first wheel.

6. The vehicle of claim 1, further comprising a fluid tank having a capacity of at least four hundred liters, wherein the fluid tank is located across a vertical plane defined by a center of the wheel and a center of the supplemental wheel.

7. The vehicle of claim 1, further comprising a spray boom cantilevered at least two meters from a first side of said frame.

8. The vehicle of claim 1, wherein the first linkage assembly is of a construction capable of raising the frame at least one half meter.

9. The vehicle of claim 1, wherein the first linkage assembly is of a construction capable of raising the frame at least seventy-five centimeters.

10. The vehicle of claim 1, wherein the first linkage assembly is of a construction capable of raising the frame at least one meter.

11. The vehicle of claim 1, wherein the first linkage assembly is of a construction capable of raising the frame at least one hundred and twenty centimeters.

12. The vehicle of claim 1, wherein the length of the first linkage is less than fifty percent the length of the second linkage.

13. The vehicle of claim 12, wherein the length of the first linkage is greater than the length of the third linkage.

14. The vehicle of claim 1, wherein the third linkage is curved.

15. The vehicle of claim 1, wherein the third linkage is generally S-shaped.

16. A vehicle comprising:
(a) a frame;
(b) a first wheel;
(c) a first leg coupled to the first wheel;
(d) a first linkage coupled between the frame and the first leg;
(e) wherein the first linkage is pivotable between a first position and a second position, wherein when the first linkage is in the first position at least a portion of the first linkage is at least one meter below the point at which the at least a portion of the first linkage is when the first linkage is in the second position;
(f) a first actuator coupled to the first linkage;
(h) a second wheel;
(i) a second leg coupled to the second wheel;
(j) a second linkage coupled between the frame and the second leg;
(f) wherein the second linkage is pivotable between a third position and a fourth position, wherein when the second linkage is in the third position at least a portion of the second linkage is at least one meter below the point at which the at least a portion of the second linkage is when the second linkage is in the fourth position; and
(l) a second actuator coupled to the second linkage.

17. The vehicle of claim 16, further comprising a third linkage pivotably coupling the first linkage to the frame.

18. The vehicle of claim 16, further comprising a fourth linkage pivotably coupled between the frame and the first linkage, wherein when the first linkage is substantially vertical, the fourth linkage is substantially horizontal, a wherein when the first linkage is substantially horizontal, the fourth linkage is substantially vertical.

19. A vehicle comprising:
(a) a frame;
(b) a wheel;
(c) a leg coupled to the wheel;
(d) a lifting linkage assembly coupled between the frame and the leg, wherein the lifting linkage has a lifting height of at least one meter; and
(e) a linear actuator pivotably coupled to the linkage assembly; and
(f) a steering actuator coupled to the first wheel substantially below the linkage assembly.

20. The vehicle of claim 19, wherein the lifting linkage assembly comprises:
(a) a first linkage assembly comprising:
(i) a first linkage pivotably coupled to the frame;
(ii) a second linkage pivotably coupled to the first linkage;
(iii) a third linkage pivotably coupled to the frame and pivotably coupled to the second linkage;
(b) a second linkage assembly comprising;
(i) fourth linkage pivotably coupled to the frame;
(ii) a fifth linkage pivotably coupled to the fourth linkage;
(iii) a sixth linkage pivotably coupled to the frame and pivotably coupled to the fifth linkage; and
(c) wherein the linear actuator is pivotably coupled to the sixth linkage.
